(19) United States
(12) Patent Application Publication
(10) Pub. No.: US 2025/0231741 A1
(43) Pub. Date: Jul. 17, 2025

(54) SYSTEMS AND METHODS FOR IMPLEMENTING A QUANTUM-INSPIRED MAXIMUM INNER PRODUCT SEARCH

(71) Applicant: JPMORGAN CHASE BANK, N.A., New York, NY (US)

(72) Inventors: Arthur G RATTEW, Sag Harbor, NY (US); Shouvanik CHAKRABARTI, Jersey City, NJ (US); Yue SUN, Short Hills, NJ (US); Pradeep NIROULA, College Park, MD (US); Marco PISTOIA, Amawalk, NY (US)

(21) Appl. No.: 18/412,323

(22) Filed: Jan. 12, 2024

(51) Int. Cl. G06F 7/523

(52) U.S. Cl. CPC G06F 7/523

(57) ABSTRACT

In some aspects, the techniques described herein relate to a method including: executing a data structure initialization process, wherein the data structure initialization process takes a real-valued array as input and creates a bag data structure for each vector in a set of vectors, and wherein the bag data structure for each vector in a set of vectors includes an index array and a probability array; providing, as input to a primary maximum inner product search process, the set of vectors, a stream of vectors, and the bag data structure for each of the vectors in the set; and determining, by a secondary maximum inner product search process for each vector in the stream of vectors, an index of the set of vectors such that the index has a maximum inner product with the vector from the stream of vectors.

### BACKGROUND

### 1. Field of the Invention

Aspects generally relate to systems and methods for implementing a quantum-inspired maximum inner product search.

### 2. Description of the Related Art

Quantum computers offer the promise of transformative change throughout a number of scientific and industrial sectors. They do so by enabling the implementation of quantum algorithms, which leverage uniquely quantum properties. Quantum algorithms are not merely classical algorithms accelerated on faster hardware. Rather, quantum algorithms leverage fundamentally different design principles. As a result, a new class of classical algorithms has emerged which draws inspiration from these quantum algorithm design techniques, earning the appropriate name of quantum-inspired algorithms. Often, under certain strong input assumptions, these techniques offer exponential improvements over the best known alternative classical algorithms.

While interesting in their own right from a theoretical perspective, in terms of practical applicability, often, the considerable degree polynomials in the complexity of quantum-inspired algorithms can preclude their real-world use. As a result, to achieve real-world value from these design techniques, it is essential to further explore quantum-inspired algorithms with at most quartic-degree polynomial dependencies. Moreover, when the objective is to outperform the most-efficient extant classical algorithm, oft-neglected constant factors and logarithmic terms also become important, as they can substantially change the scale at which the asymptotic advantages of quantum-inspired QI techniques beat the favorable constant factors of highly optimized traditional classical algorithms.

For instance, a quantum-inspired algorithm with an asymptotic complexity that only yields practical advantage at a larger scale may not be usefully applied, in practice, to a problem with inputs of a certain size. Towards this end, the notion of a QI crossover point may be defined. That is, for families of problems with varying input sizes, the QI crossover point may be defined as the problem scale at which the quantum-inspired solution yields better asymptotic performance (under some metric) than the traditional classical approaches.

### SUMMARY

In some aspects, the techniques described herein relate to a method executed by a computing device including a processor and a memory, including: executing a data structure initialization process, wherein the data structure initialization process takes a real-valued array as input and creates a bag data structure for each vector in a set of vectors {Xᵢ}_{i∈[d]}, and wherein the bag data structure for each vector in a set of vectors {Xᵢ}_{i∈[d]} includes an index array and a probability array; providing, as input to a primary maximum inner product search process, the set of vectors {Xᵢ}_{i∈[d]}, a stream of vectors {Yᵢ}, and the bag data structure for each of the vectors in the set {Xᵢ}i∈[d]; and determining, by a secondary maximum inner product search process for each Yⱼ, an index is of the set of vectors {Xᵢ}_{i∈[d]} such that Xᵢ, has a maximum inner product with Yⱼ, wherein the secondary maximum inner product search process executes a primary inner product approximation process, including: for each Xᵢ in the set of vectors {Xᵢ}_{i∈[d]}, approximately computing, by the primary inner product approximation process, an inner product of Xᵢ and Yᵢ, up to a provided error tolerance, relative to L2 norms of Xᵢ and Yⱼ, and with a provided success probability.

In some aspects, the techniques described herein relate to a method, including: calling, by the primary inner product approximation process, a secondary inner product approximation process K times, wherein K is determined by the provided success probability.

In some aspects, the techniques described herein relate to a method, including: determining, by the secondary inner product approximation process, K estimates of the inner product of Xᵢ and Yⱼ.

In some aspects, the techniques described herein relate to a method, including: computing, by the primary inner product approximation process, a median of the K estimates.

In some aspects, the techniques described herein relate to a method, including: returning, by the primary inner product approximation process, the median of the K estimates to the secondary maximum inner product search process as an inner product approximation.

In some aspects, the techniques described herein relate to a method, including: for each time the secondary inner product approximation process is called, randomly sampling, by the secondary inner product approximation process and from the bag data structure of Xᵢ to determine an index k, and probability pₖ, of which the index k is produced.

In some aspects, the techniques described herein relate to a method, including: multiplying, by the secondary inner product approximation process a k-th element of Xᵢ and a k-th element of Yⱼ, wherein k is given via the random sampling of the bag data structure of Xᵢ.

In some aspects, the techniques described herein relate to a method, including: repeating the random sampling of the bag data structure of Xᵢ and the multiplication L times, wherein L is determined by the provided error tolerance.

In some aspects, the techniques described herein relate to a method, including: summing products of all repetitions to determine an estimate for the inner product of Xᵢ and Yⱼ.

### BRIEF DESCRIPTION OF THE DRAWINGS

FIG. 1 is a logical flow for implementing a quantum-inspired maximum inner product search, in accordance with aspects.

FIG. 2 is a logical flow of a primary and a secondary inner product approximation process, in accordance with aspects.

FIG. 3 is a logical flow of a secondary inner product approximation process, in accordance with aspects.

FIG. 4 is a block diagram of a technology infrastructure and computing device for implementing certain aspects of the present disclosure, in accordance with aspects.

### DETAILED DESCRIPTION

Aspects generally relate to systems and methods for implementing a quantum-inspired maximum inner product search process.

In accordance with aspects, an inner product may be described as a way to multiply vectors. The inner product of the vectors may be a scalar. A maximum inner product search may utilize algorithmic techniques to maximize a determined inner product between a query and the data items to be retrieved by an associated query. Aspects described herein may provide a quantum-inspired algorithm, or algorithms (also referred to herein as “processes”), for approximately computing an inner product and performing a maximum inner product search. Aspects may include a novel data structure, referred to herein as a “bag” data structure, in determining an inner product and performing an inner product search.

In accordance with aspects, a problem for inner product computation may assume that two factors (e.g., x and y) of a same size (e.g., size N) are given and the norm of one factor (e.g., y) is known. Some level of query access may be assumed. Query access is described in more detail, herein. Output, then, may be some approximate value of the inner product of x and y. Approximation error may be given by the relative error with respect to, e.g., L2 norms of the two factors x and y. This error bound may be guaranteed within a probability of at least 1 minus an arbitrarily small positive value of delta.

In exemplary aspects, given two lists of numbers (e.g., two arrays) containing real numbers (e.g., of a length of 1 million each), the inner product of the two arrays is defined as the sum over i of xᵢyᵢ. That is, to arrive at the inner product of two arrays, elements of respective positions in two corresponding arrays may be multiplied, and then all of the products may be summed (i.e., added together).

In such a scenario, the inner product between x and a large number of different ys may be computed. Since, in various scenarios, x may be known in advance, an efficient data structure based on x may be constructed and a cost of building the data structure may be amortized. The efficiency of the data structure may then be utilized in approximately computing an inner product as is described above.

In accordance with aspects, given an N-dimensional real vector x E [symbol] ^{N}, xⱼ may be used to denote the j-th element of the vector. The L2 norm of the

$${‖ x ‖}_{2} = \sqrt{{\sum }_{j = 1}^{d} {x}_{j}^{2}} .$$

vector v may be defined as In terms of query access (i.e., Q), given an N-dimensional real vector x∈ [symbol] ^{N}, it may be said that query access is obtained to x, denoted as Q(x). If given an index j∈[N] the value xⱼ may be returned with constant time-complexity, where xⱼ is the j-th element of the vector x. In classical random-access memory, this implies that given an index, an array element stored in memory at that index may be accessed with constant time (i.e., given an index value, a value stored at the array element associated with the index value may be returned when it is requested).

In accordance with aspects, a special data structure may be constructed from one of the input factors x. This data structure may allow for efficient implementation of a quantum inspired approximate inner product search. This data structure is referred to herein as a “bag” data structure. In exemplary aspects of a quantum-inspired approximate inner product search using a bag data structure, K may represent a number of buckets, and L may represent the size of each bucket (or the number of samples in each bucket). Each bucket may store the approximations that are needed to approximately compute an inner product. These buckets may be computed from the error and probability bounds noted, above.

Aspects may iterate through each bucket and draw samples needed for that bucket from the bag data structure. For each sample withdrawn from the bag data structure of x, the sample may provide an index within a range of the index that is allowed for x and y, since both arrays x and y are of the same length. This index may be represented by the variable j. A sampling may also return the probability of getting a sample producing that index from the bag data structure.

In accordance with aspects, a bag data may be initialized in random access memory of a computing device. An initialization process of a bag data structure may take an N-dimensional real vector x with Q(x) as input. A bag data structure may include two arrays. A first array may be an index array (e.g., an index array v) and a second array may be a probability array (e.g., a probability array p). Both arrays may have query access, as defined herein. An element in the index array may be a value j that represents an index to the vector x, which may be used to query xⱼ. Each value j may be repeated m; times in the index array v, where mⱼ is the smallest integer no less than xⱼ²N/∥x∥₂², such that the size of the index array may be M=Σⱼ₌₁^{N}mⱼ. The probability array p may be of size N.

When sampling uniformly from index array v, an index value j is produced with probability pⱼ=mⱼ/M. The j-th element of the array p (i.e., pⱼ) gives this probability. The index value j references the corresponding value at the j-th element of the real vector x (i.e., xⱼ).

In initializing a bag data structure (and as noted, above), the L2 norm of an input N-dimensional real vector x may be computed as the square root of the sum of squares of all of the elements of the N-dimensional real vector x. That is, the L2 norm of the vector x may be defined as

$${‖ x ‖}_{2} = \sqrt{{\sum }_{j = 1}^{d} {x}_{j}^{2}} .$$

In initialization of the bag data structure, this norm may be computed and stored for later use. The L2 norm may be a single value.

An initializing process for a bag data structure may include creating an empty temporary counting array m having an integer data type and of size N (i.e., an array having the same number of elements as the number of dimensions as the real vector x used as input). The counting array m may be used to store the intermediate result of the number of repetitions (i.e., mⱼ) for each index j in the index vector v. The probability array p may also be empty and may be a real-valued array.

In accordance with aspects, in generation of a bag data structure for a given vector, a scalar variable M may be set to 0 (i.e., M=0). Then, using a for-loop, for j=1 to N, the j-th element of m (i.e., mⱼ), may be set to the smallest integer no less than xⱼ²N/∥x∥₂². Then, the variable M may be incremented by mⱼ in each iteration of the for loop.

Next, the bag data structure initialization process may create the index array v, which may be an empty real-valued array of size M. A variable l may be set to 1 (i.e., l=1). Then, a for-loop may execute a nested for-loop. That is, for j=1 to N, set pⱼ=mⱼ/M, and the nested for-loop may be executed. The nested for loop may be written as: for k=1 to mⱼ, Set vₗ=xⱼ, increment l by 1. After the execution of the outer for-loop, the temporary counting array m may be deleted. The bag data structure initialization process may then return the bag data structure for the input N-dimensional real vector x (i.e., bag(x)) with index array v and probability array p.

In accordance with aspects, a quantum-inspired approximate maximum inner product search process (i.e., a primary maximum inner product search process, also referred to herein as a primary search process) may take, as input, a database of d real-valued row-vectors (i.e., {Xᵢ}_{i∈}[d]) with dimensions N×1, and for each vector Xᵢ query access (i.e., Q(Xᵢ)) may be given. A stream of real-valued column-vectors {Yⱼ} with dimensions 1×N, along with Q(Yⱼ) an error parameter ε>0, and a failure probability 0<δ<1 may also be input to the quantum-inspired approximate maximum inner product search process.

In accordance with aspects, a primary search process may initialize a bag data structure, as described herein, for each Xᵢ of the set of vectors {Xᵢ}_{i∈[d]} in the database. Then the primary process may initiate a for-loop where, for each value j in the stream of real-valued column-vectors, a secondary maximum inner product search process (referred to herein as a secondary search process) may be called/executed. The secondary search process may be configured to return the index i, of the set of vectors {Xᵢ}_{i∈[d]} that has the maximum inner product with Yᵢ using bag data structures of the set of vectors {Xᵢ}_{i∈[d]} that are initialized as part of the primary search process. That is, a quantum-inspired approximate maximum inner product search process may return, for each Yⱼ and with success probability 1−δ, an index i. ∈[d] where |Xᵢ, Yⱼ−Xᵢ, Yⱼ|≤ε∥Yⱼ∥, such that i, =argmax_{i∈[d]} XᵢYⱼ. Thus, the output is ix for each factor in stream {Yⱼ} (i.e., each j as processed by the for-each loop of the primary search process).

In accordance with aspects, a secondary inner product search process (i.e., a second quantum-inspired approximate maximum inner product search process called from within a for-each loop of a primary quantum-inspired approximate maximum inner product search process) may take, as input: a database of d real-valued row-vectors {Xᵢ}_{i∈[d]} with dimensions N×1, where, for each vector Xᵢ, bag (Xᵢ) is given by the primary search process; a real-valued column-vector y having dimensions 1×N, along with Q(y); and an error parameter ε>0, and a failure probability 0<δ<1. The secondary search process may output, with success probability 1-δ, an index i, ∈[d] where |Xᵢ,y−Xᵢ, y|≤ε∥y∥₂ such that i_{*}=argmax_{i∈[d]}Xᵢy.

An exemplary secondary inner product search process may set a variable Zx=−∞. Then, in a for-loop for i=1 to d, the process may approximate an inner product Xᵢy having error ε/(2∥Xᵢ∥₂) and failure probability δ/d, and may store the result in a variable z. The for-loop of the secondary inner product search process may call an inner product approximation process, which may return the inner product Xᵢy, and which is described in more detail, below. The for-loop of the secondary inner product search process may continue if z>z_{*} then i may be set equal to i and z may be set equal to z (i.e., set i_{*}=i, z_{*}=z). Then, the for-loop may end, and i_{*} may be returned to the primary search process.

In accordance with aspects, a primary inner product approximation process may be called by a secondary inner product search process and may be configured to approximate an inner product of Xᵢy. A primary inner product approximation process may take, as input: A real-valued row-vector x with dimensions N×1 along with bag(x); a real-valued column-vector y with dimensions 1×N, along with Q(y); an error parameter ε>0; and a failure probability 0<δ<1. The primary inner product approximation process may output \hat{Z} satisfying |\hat{Z}−xy|≤∈∥x∥₂∥y∥₂ with probability at least 1-8.

An exemplary primary inner product approximation process may set a variable K to the smallest integer that is no less than 6 log₂

$$\frac{2}{δ} ,$$

and a variable L to the smallest integer that is no less than

$$\frac{9}{{ϵ}^{2}} .$$

The primary inner product the approximation process may create an empty array s of size K for storing real numbers. A for loop of the inner product approximation process may, for k=1 to K, set the k-th element of s to 0 (i.e., sₖ=0). Then, in a nested for loop (referred to herein as a secondary inner product approximation process), for l=1 to L, a sample (e.g., a random sample) from input bag(x) may be sampled to retrieve index j, and probability pⱼ. In the nested for loop, sₖ may then be incremented by xⱼyⱼ/pⱼ. Thereafter the nested for loop may end and the primary for loop may also end.

A primary inner product approximation process may then compute the median of the elements stored in array s by calling a median computation process. The median computation process may include a selection by partial sorting process. The selection by partial sorting process may take as an input an unsorted real-valued array x of size N with Q(x) and an order number k∈[N], and return the k-th largest element of x by partially sorting the array x. The selection by partial sorting process may use an Introselect algorithm. An Introselect algorithm is described in Introspective Sorting and Selection Algorithms. Softw: Pract. Exper., 27:983-993, MUSSER, D. R. (1997), the disclosure of which is hereby incorporated by reference in its entirety. The primary inner product approximation process may call a median computation process as a subroutine, and the median computation process may call a selection method and pass it parameters.

For example, a primary inner product approximation process may call a median computation process and may pass the median computation process an K-dimensional real vector s with Q(s) as input. A median computation algorithm may evaluate K and if K is odd (an odd integer) then a selection by partial sorting method (e.g., Introselect) may be called and may be passed input array s and order number k=(K+1)/2 (i.e., Introselect (s, (K+1)/2)). The median computation algorithm may return, to the primary inner product approximation process the results of the selection by partial sorting method (i.e., Introselect (s, (K+1)/2)). If, on the other hand, K is an even integer, the median computation process may be called and may return (Introselect (s, K/2)+Introselect (s, K/2+1))/2. The above median computation process based on Introselect is exemplary, and other selection processes, algorithms, etc., may be used.

In accordance with aspects, a median computation algorithm, such as that described herein, may return, to a calling primary inner product approximation process, the median of elements in s from an K-dimensional real vector s with Q(s) passed as input to the median computation algorithm. The primary inner product approximation process may then return (e.g., to a calling secondary maximum inner product search process) \hat{Z}, where

$$\hat{Z} = median ( s ) \frac{N}{L} ,$$

where median(s) is the median computed and returned by the median computation algorithm.

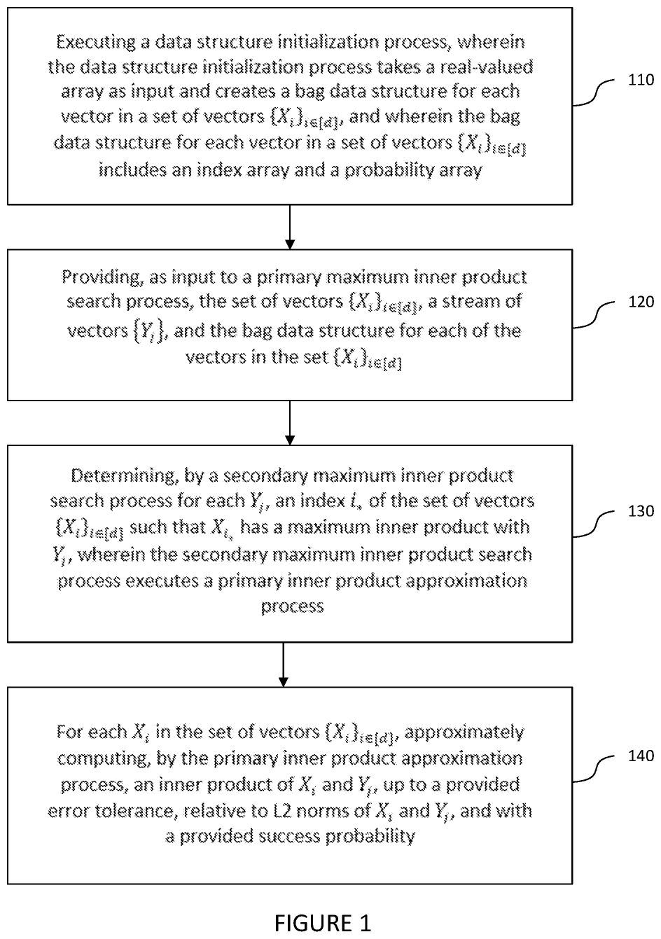

FIG. 1 is a logical flow for implementing a quantum-inspired maximum inner product search, in accordance with aspects.

Step 110 includes executing a data structure initialization process, wherein the data structure initialization process takes a real-valued array as input and creates a bag data structure for each vector in a set of vectors {Xᵢ}_{i∈[d]}, and wherein the bag data structure for each vector in a set of vectors {Xᵢ}_{i∈[d]} includes an index array and a probability array.

Step 120 includes providing, as input to a primary maximum inner product search process, the set of vectors {Xᵢ}_{i∈[d]}, a stream of vectors {Yⱼ}, and the bag data structure for each of the vectors in the set {Xᵢ}_{i∈[d]}.

Step 130 includes determining, by a secondary maximum inner product search process for each Yⱼ, an index i_{*} of the set of vectors {Xᵢ}_{i∈[d]} such that Xᵢ, has a maximum inner product with Yⱼ.

Step 140 includes executing, by the secondary maximum inner product search process, a primary inner product approximation process, including for each Xᵢ in the set of vectors {Xᵢ}_{i∈[d]}, approximately computing, by the primary inner product approximation process, an inner product of Xᵢ and Yⱼ, up to a provided error tolerance, relative to L2 norms of Xᵢ and Yⱼ, and with a provided success probability.

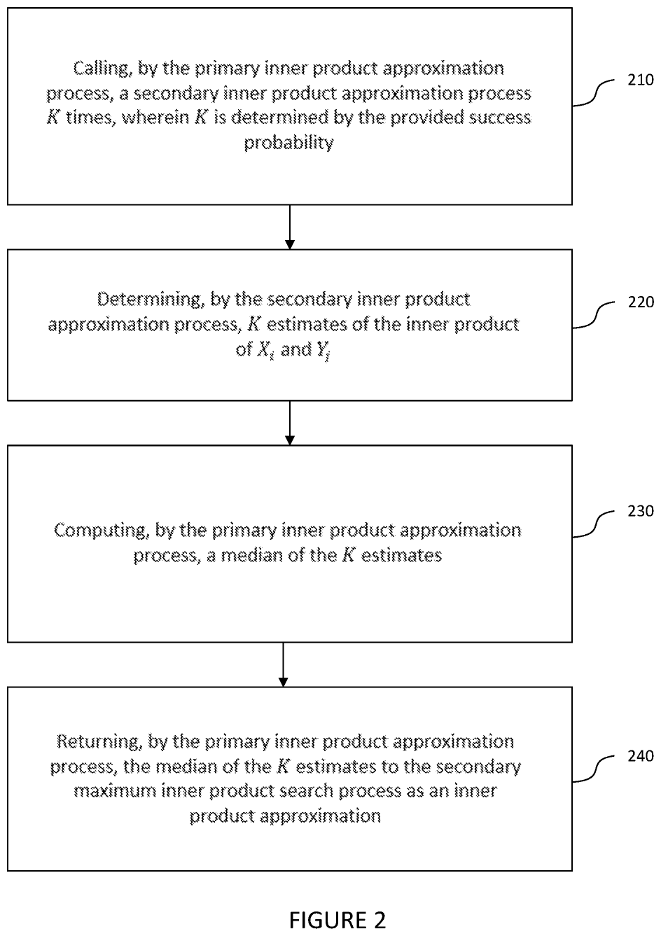

FIG. 2 is a logical flow of a primary and a secondary inner product approximation process, in accordance with aspects.

Step 210 includes calling, by a primary inner product approximation process, a secondary inner product approximation process K times, wherein K is determined by the provided success probability.

Step 220 includes determining, by the secondary inner product approximation process, K estimates of the inner product of Xᵢ and Yⱼ.

Step 230 includes computing, by the primary inner product approximation process, a median of the K estimates.

Step 240 includes returning, by the primary inner product approximation process, the median of the K estimates to the secondary maximum inner product search process as an inner product approximation.

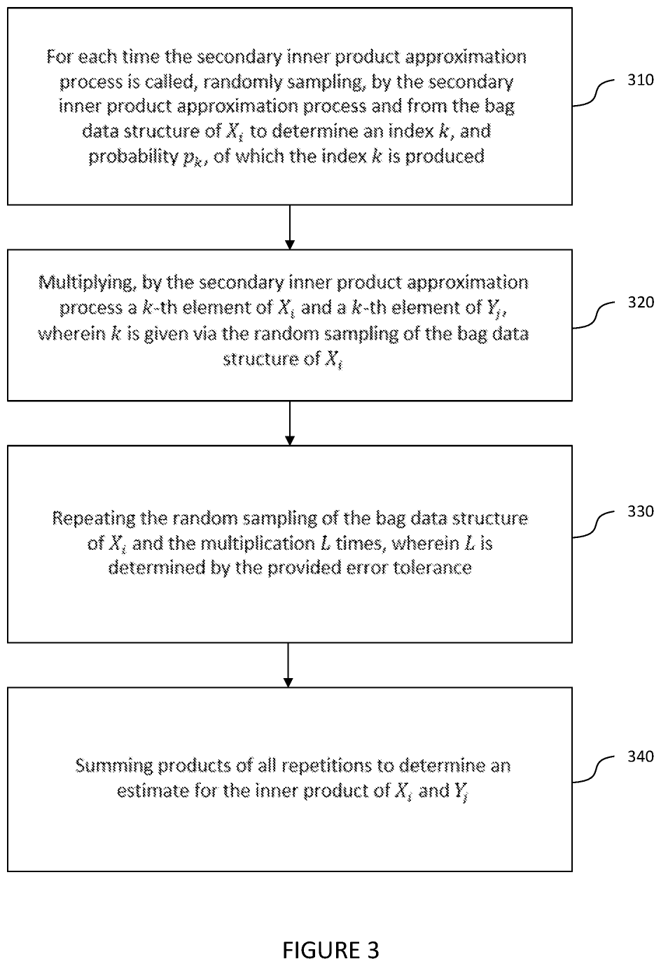

FIG. 3 is a logical flow of a secondary inner product approximation process, in accordance with aspects.

Step 310 includes, for each time the secondary inner product approximation process is called, randomly sampling, by the secondary inner product approximation process and from the bag data structure of Xᵢ to determine an index k, and probability pₖ, of which the index k is produced.

Step 320 includes multiplying, by the secondary inner product approximation process a k-th element of Xᵢ and a k-th element of Yⱼ, wherein k is given via the random sampling of the bag data structure of Xᵢ.

Step 330 includes repeating the random sampling of the bag data structure of Xᵢ and the multiplication L times, wherein L is determined by the provided error tolerance.

Step 340 includes summing products of all repetitions to determine an estimate for the inner product of Xᵢ and Yⱼ.

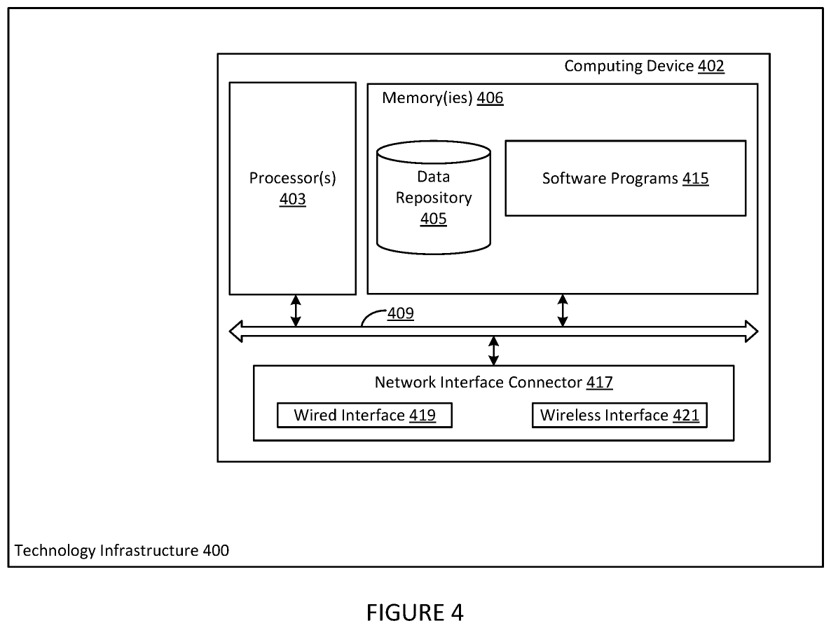

FIG. 4 is a block diagram of a technology infrastructure and computing device for implementing certain aspects of the present disclosure, in accordance with aspects. FIG. 4 includes technology infrastructure 400. Technology infrastructure 400 represents the technology infrastructure of an implementing organization. Technology infrastructure 400 may include hardware such as servers, client devices, and other computers or processing devices. Technology infrastructure 400 may include software (e.g., computer) applications that execute on computers and other processing devices. Technology infrastructure 400 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 400 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 400 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 400 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 400 may include both wired and wireless components and interfaces and may interface with servers and other hardware via either wired or wireless communications. A computer network of technology infrastructure 400 may be a private network but may interface with a public network (such as the internet) to facilitate operative communication between computers executing on technology infrastructure 400 and computers executing outside of technology infrastructure 400.

FIG. 4 further depicts exemplary computing device 402. Computing device 402 depicts exemplary hardware that executes the logic that drives the various system components described herein. Servers and client devices may take the form of computing device 402. While shown as internal to technology infrastructure 400, computing device 402 may be external to technology infrastructure 400 and may be in operative communication with a computing device internal to technology infrastructure 400.

In accordance with aspects, system components such as client devices, servers, various database engines and database services, and other computer applications and logic may include, and/or execute on, components and configurations the same, or similar to, computing device 402.

Computing device 402 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 402 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method executed by a computing device including a processor and a memory, comprising:
executing a data structure initialization process, wherein the data structure initialization process takes a real-valued array as input and creates a bag data structure for each vector in a set of vectors {Xᵢ}_{i∈[d]}, and wherein the bag data structure for each vector in a set of vectors {Xᵢ}_{i∈[d]} includes an index array and a probability array;
providing, as input to a primary maximum inner product search process, the set of vectors {Xᵢ}_{i∈[d]}, a stream of vectors {Yⱼ}, and the bag data structure for each of the vectors in the set {Xᵢ}_{i∈[d]}; and
determining, by a secondary maximum inner product search process for each Yⱼ, an index i, of the set of vectors {Xᵢ}_{i∈[d]} such that Xᵢ, has a maximum inner product with Yⱼ, wherein the secondary maximum inner product search process executes a primary inner product approximation process, including:
for each Xᵢ in the set of vectors {Xᵢ}_{i∈[d]}, approximately computing, by the primary inner product approximation process, an inner product of Xᵢ and Yⱼ, up to a provided error tolerance, relative to L2 norms of Xᵢ and Yⱼ, and with a provided success probability.

2. The method of claim 1, comprising:
calling, by the primary inner product approximation process, a secondary inner product approximation process K times, wherein K is determined by the provided success probability.

3. The method of claim 2, comprising:
determining, by the secondary inner product approximation process, K estimates of the inner product of Xᵢ and Yⱼ.

4. The method of claim 3, comprising:
computing, by the primary inner product approximation process, a median of the K estimates.

5. The method of claim 4, comprising:
returning, by the primary inner product approximation process, the median of the K estimates multiplied by N/L to the secondary maximum inner product search process as an inner product approximation.

6. The method of claim 2, comprising:
for each time the secondary inner product approximation process is called, randomly sampling, by the secondary inner product approximation process and from the bag data structure of Xᵢ to determine an index k, and probability pₖ, of which the index k is produced.

7. The method of claim 6, comprising:
multiplying, by the secondary inner product approximation process a k-th element of Xᵢ and a k-th element of Yⱼ, wherein k is given via the random sampling of the bag data structure of Xᵢ.

8. The method of claim 7, comprising:
repeating the random sampling of the bag data structure of Xᵢ and the multiplication L times, wherein L is determined by the provided error tolerance.

9. The method of claim 8, comprising:
summing products of all repetitions to determine an estimate for the inner product of Xᵢ and Yⱼ.

10. A system comprising at least one computer including a processor, wherein the at least one computer is configured to:
execute a data structure initialization process, wherein the data structure initialization process takes a real-valued array as input and creates a bag data structure for each vector in a set of vectors {Xᵢ}_{i∈[d]}, and wherein the bag data structure for each vector in a set of vectors {Xᵢ}_{i∈[d]} includes an index array and a probability array;
provide, as input to a primary maximum inner product search process, the set of vectors {Xᵢ}_{i∈[d]}, a stream of vectors {Yⱼ}, and the bag data structure for each of the vectors in the set {Xᵢ}_{i∈[d]}; and
determine, by a secondary maximum inner product search process for each Yⱼ, an index i, of the set of vectors {Xᵢ}_{i∈[d]} such that Xᵢ, has a maximum inner product with Yⱼ, wherein the secondary maximum inner product search process executes a primary inner product approximation process configured to:
for each Xᵢ in the set of vectors {Xᵢ}_{i∈[d]}, approximately compute, by the primary inner product approximation process, an inner product of Xᵢ and Yⱼ, up to a provided error tolerance, relative to L2 norms of Xᵢ and Yⱼ, and with a provided success probability.

11. The system of claim 10, wherein the at least one computer is configured to:
call, by the primary inner product approximation process, a secondary inner product approximation process K times, wherein K is determined by the provided success probability.

12. The system of claim 11, wherein the at least one computer is configured to:
determine, by the secondary inner product approximation process, K estimates of the inner product of Xᵢ and Yⱼ.

13. The system of claim 12, wherein the at least one computer is configured to:
compute, by the primary inner product approximation process, a median of the K estimates.

14. The system of claim 13, wherein the at least one computer is configured to:
return, by the primary inner product approximation process, the median of the K estimates multiplied by N/L to the secondary maximum inner product search process as an inner product approximation.

15. The system of claim 11, wherein the at least one computer is configured to:
for each time the secondary inner product approximation process is called, randomly sample, by the secondary inner product approximation process and from the bag data structure of Xᵢ to determine an index k, and probability pₖ, of which the index k is produced.

16. The system of claim 15, wherein the at least one computer is configured to:
multiply, by the secondary inner product approximation process a k-th element of Xᵢ and a k-th element of Yⱼ, wherein k is given via the random sampling of the bag data structure of Xᵢ.

17. The system of claim 16, wherein the at least one computer is configured to:
repeat the random sampling of the bag data structure of Xᵢ and the multiplication L times, wherein L is determined by the provided error tolerance.

18. The system of claim 17, wherein the at least one computer is configured to:
sum products of all repetitions to determine an estimate for the inner product of Xᵢ and Yⱼ.

19. A non-transitory computer readable storage medium, including instructions stored thereon, which instructions, when read and executed by one or more computer processors, cause the one or more computer processors to perform steps comprising:
executing a data structure initialization process, wherein the data structure initialization process takes a real-valued array as input and creates a bag data structure for each vector in a set of vectors {Xᵢ}_{i∈[d]}, and wherein the bag data structure for each vector in a set of vectors {Xᵢ}_{i∈[d]} includes an index array and a probability array;
providing, as input to a primary maximum inner product search process, the set of vectors {Xᵢ}_{i∈[d]}, a stream of vectors {Yⱼ}, and the bag data structure for each of the vectors in the set {Xᵢ}_{i∈[d]}; and
determining, by a secondary maximum inner product search process for each Yⱼ, an index i, of the set of vectors {Xᵢ}_{i∈[d]} such that Xᵢ, has a maximum inner product with Yⱼ, wherein the secondary maximum inner product search process executes a primary inner product approximation process, including:
for each Xᵢ in the set of vectors {Xᵢ}_{i∈[d]}, approximately computing, by the primary inner product approximation process, an inner product of Xᵢ and Yⱼ, up to a provided error tolerance, relative to L2 norms of Xᵢ and Yⱼ, and with a provided success probability.

20. The non-transitory computer readable storage medium of claim 19, comprising:
calling, by the primary inner product approximation process, a secondary inner product approximation process K times, wherein K is determined by the provided success probability.
